(19) United States
(12) Patent Application Publication
(10) Pub. No.: US 2007/0094599 A1
(43) Pub. Date: Apr. 26, 2007

(54) METHOD AND SYSTEM FOR TRAINING AN OPERATOR OF A PAPER FOLDING MACHINE

(75) Inventors: Mark PELLMAN, Heidelberg, OH (DE); Dave NEWMAN, Heidelberg, OH (DE); Dave WAGNER, Heidelberg, OH (DE); Mark WALKER, Heidelberg, OH (DE); Howard SLUSHER, Heidelberg, OH (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: Heidelberger Druckmaschinen Aktiengesellschaft, Heidelberg (DE)

(21) Appl. No.: 11/380,337

(22) Filed: Apr. 26, 2006

Related U.S. Application Data
(60) Provisional application No. 60/714,967, filed on Sep. 8, 2005.

(51) Int. Cl. G03G 15/00

(52) U.S. Cl. 715/705; 399/81

(57) ABSTRACT

An interactive tutorial teaches an operator all of the required information needed to set up, operate, maintain, and troubleshoot a folding machine. The interactive tutorial includes graphic and text displays that provide all the necessary information to the operator or short videos to show exactly how an operation should be carried out. The tutorial preferably uses a touchscreen with buttons that allow the operator to select one from several displayed folder functions, see further information regarding a particular operation, or jump to another screen. In one embodiment, the displayed information in the tutorial is not used to control any functions of the folding machine and may include at least one of an operating manual, a maintenance procedure, and a troubleshooting operation. In another embodiment, the interactive tutorial can be upgraded and then connected to the folding machine after the training of the operator has been completed to control the functions of the folding machine using the displayed functions.

This application claims the benefit of U.S. Provisional Application No. 60/714,967, filed Sep. 8, 2005.

### BACKGROUND OF THE INVENTION

1. Field of the Invention

The present invention relates to an interactive training tutorial for a paper folding machine which can train an operator to perform all folder related functions.

1. Description of the Related Art

It is known in the art to locate a computerized touchscreen at the folder to enable an operator to remotely set up motorized components within the folder for a subsequent folding operation. This automates some of the folder functions but does not teach the operator how to use the folder nor does the operator have access to information regarding operation, maintenance, or troubleshooting of the folder. Merely motorizing some of the functions of the folder does not ensure that the operator adequately learns how a folder should be configured for a folding operation. Furthermore, an inexperienced operator must be supervised when controlling the folder so as not to damage the machine and to guarantee that the folder is configured properly.

### SUMMARY OF THE INVENTION

In order to overcome the problems described above, preferred embodiments of the present invention provide an interactive tutorial that can teach an operator all of the required information needed to set up, operate, maintain, and troubleshoot a folder. The interactive tutorial includes graphic and text displays that provide all the necessary information to the operator. Video displays can show a short video to the tutorial operator to show exactly how an operation should be carried out. The tutorial preferably uses a touchscreen with buttons that allow the operator to select one from several displayed folder operations, see further information regarding a particular operation, or jump to another screen, for example.

A preferred embodiment of the present invention provides a computerized tutorial for training an operator to operate a folding machine including displaying on a display functions of the folding machine and information regarding the folding machine; selecting one of the functions and information from the displayed functions and information based on input from the operator; inputting, selecting, or retrieving data based on the selected one of the plurality of functions and information; and operating the computerized tutorial in a state in which the computerized tutorial is disconnected from the folding machine so as not to control any functions of the folding machine.

The displayed information is not used to control the functions of the folding machine and may include at least one of an operating manual, a maintenance procedure, and a troubleshooting operation. The displayed information may include videos which display various operations regarding the folding machine.

Another preferred embodiment of the present invention includes, after the training of the operator has been completed, using an upgraded version of the tutorial to control the folding machine using the functions provided in the tutorial. In a preferred embodiment, the inputting, selecting or retrieving data is performed using a touch screen of the display.

Another preferred embodiment of the present invention provides a system for training an operator to operate a folding machine including a storage device in which functions of the folding machine and information regarding a folding machine are stored, a display on which the functions of the folding machine and information regarding the folding machine are displayed, and an input device provided to allow the operator to select one of the functions and the information displayed on the display, wherein the system can be disconnected from the folding machine during the training of the operator during which the system does not control any functions of the folding machine and operates only as a tutorial.

In a preferred embodiment, the displayed information is not used to control the functions of the folding machine and may include at least one of an operating manual, a maintenance procedure, and a troubleshooting operation. The displayed information may include videos which display various operations regarding the folding machine.

According to another preferred embodiment of the present invention, the system can be upgraded and then connected to the folding machine after the training of the operator has been completed to control the functions of the folding machine using the displayed functions. Preferably, the input device is a touch screen of the display.

According to another preferred embodiment of the present invention, a computer-readable medium includes computer-executable instructions for tutoring an operator to operate a folding machine; displaying on a display functions of the folding machine and information regarding the folding machine; selecting one of the functions and information from the displayed functions and information based on user input; inputting, selecting, or retrieving data based on the selected one of the plurality of functions and information; and tutoring the operator to operate a folding machine independent of the folding machine so as not to control any functions of the folding machine.

In a preferred embodiment, the displayed information is not used to control the functions of the folding machine and may include at least one of an operating manual, a maintenance procedure, and a troubleshooting operation. The displayed information may include videos which display various operations regarding the folding machine.

According to another preferred embodiment of the invention the computer-readable medium can include upgraded computer-executable instructions for controlling the folding machine using the displayed functions after the training of the operator has been completed.

According to another preferred embodiment of the present invention, a computer system having a graphical user interface includes a display and a selection device wherein a method of providing and selecting from a menu on the display includes displaying a menu of functions of a folding machine and information regarding the folding machine to an operator, receiving a menu selection signal indicating which of the functions and information was selected with the selection device, displaying data in response to the selected function or information, and operating the computer system in a state in which the computer system does not control the functions of the folding machine.

Other features, elements, steps, characteristics and advantages of the present invention will become more apparent from the following detailed description of preferred embodiments with reference to the attached drawings.

### BRIEF DESCRIPTION OF THE DRAWINGS

FIG. 1A shows a main computer screen of the tutorial which provides the operator with information about the current job status and buttons enabling all folder set up and associated functions.

FIG. 1B shows a help screen explaining the information displayed in the main screen.

FIG. 2 shows a screen of a sixteen page folding station with buttons for adjusting the folding plates and gapsets of the station.

FIG. 3 shows a screen of an eight page folding station with buttons for adjusting the folding plates and gapsets of the station.

FIG. 4 shows a screen of a parallel folding station with buttons for adjusting the folding plates and gapsets of the station.

FIG. 5 shows a fold recall screen for selecting a previously saved fold job.

FIG. 6 shows a save screen for storing the current fold job.

FIG. 7 shows a job calculator screen that calculates the production rate and other data for the current fold job.

FIGS. 8A and 8B show maintenance and maintenance item screens for displaying information regarding maintenance of the folder, respectively.

FIG. 9 shows an operation manuals screen which enables the operator to select and view one of several operating manuals for the folder.

FIG. 10 shows a troubleshooting screen which enables the operator to select from a list of troubleshooting categories.

FIG. 11 shows a first setup screen for selecting a fold for a new fold job.

FIG. 12 shows a second setup screen for selecting the paper size.

FIG. 13 shows a third setup screen for setting up the feeder.

FIGS. 14A-14C show a fourth setup screen and two instructional video screens for further setting up the feeder.

FIG. 15 shows a fifth setup screen for setting the parallel station gapsets.

FIG. 16 shows a sixth setup screen for setting the parallel station fold plates.

FIG. 17 shows a seventh setup screen for setting the parallel station slitter shaft.

FIG. 18 shows a ninth setup screen for setting the eight page cross carrier.

FIG. 19 shows a tenth setup screen for setting the eight page station gapsets.

FIGS. 20A and 20B show an eleventh setup screen for setting the eight page station fold plates and an instructional video screen, respectively.

FIG. 21 shows a twelfth setup screen suggesting the number of scoring dies for the eight page station.

FIG. 22 shows a thirteenth setup screen instructing the operator to run a second test sheet.

FIG. 23 shows a fourteenth setup screen for setting the sixteen page cross carrier.

FIG. 24 shows a fifteenth setup screen for setting the sixteen page station gapsets.

FIG. 25 shows a sixteenth setup screen for setting the sixteen page station fold plates.

FIG. 26 shows a seventeenth setup screen for setting the sixteen page station slitter shaft.

FIG. 27 shows an eighteenth setup screen instructing the operator to run a third test sheet.

FIGS. 28A and 28B show a nineteenth setup screen for setting the delivery stacker and the nineteenth setup screen with a setup list displayed, respectively.

FIG. 29A shows a job summary screen providing a complete tabular description of the current fold job.

FIG. 29B shows a job notes screen which enables an operator to enter and save comments regarding each fold job.

### DETAILED DESCRIPTION OF PREFERRED EMBODIMENTS

Various preferred embodiments according to the present invention will now be described with reference to the drawings. Each screen in the tutorial may include background information, a graphic display, a data display, buttons or activators, data entry, and instructional videos.

The background information includes a brief description or identification of the picture or graphics that provide the screen background. The graphic display information includes graphics (lights, bars, etc.) that appear on the screen indicating the machine status or other information in graphical form. The data display includes data (fold descriptions, operator information, stored job information, etc.) that are to be shown on the screen. The buttons or activators provide screen hot spots or button graphics that cause the system to react, usually a transition to another screen, when tapped or pressed by the operator. Hereafter, the buttons and activators will simply be referred to as the buttons. The data entry identifies data (job order number, paper width, etc.) and the format of data entry. Data entry is performed using a keypad or keyboard graphic. Furthermore, instructional videos may be included in any screen to provide further information or assistance to the operator in carrying out a task.

A power up screen is displayed as the first application screen after powering up the tutorial. The tutorial is otherwise configured to start with no operator interaction. Although the tutorial operates using a conventional computer operating system (Microsoft Windows XP Pro, for example), the operator is prevented from accessing the operating system. The purpose of this screen is to provide an introductory screen with an initial option to configure the tutorial to correspond to a particular folder so that the tutorial accurately tracks the operation of the particular folder. The tutorial may be configured to correspond to any known folder. Once the folder is configured, this screen only shows a start folding button, and the option to configure the folder is no longer shown. The background of this screen includes, for example, a picture of a folder, a company logo, or both. The buttons on this screen include a configure folder button, if the folder has not been configured, and a start folding button. If the configure folder button is selected, a configuration screen is displayed. If the start folding button is selected, the tutorial proceeds to a main screen. A language selection button group includes buttons that enable selection of the language to be used in the tutorial. In a preferred embodiment, the buttons are labeled for English, German, Spanish, and French. However, any suitable language may be included in the language selection button group. A measurement units selection includes a button which enables the toggling of the measurement units between standard and metric.

If the folder is not configured, the configuration screen provides for the identification of the folder configuration, including the number of foldplates on the parallel station (2, 3, 4, or 6 foldplates), the eight page station (0, 2, 3, 4 or 6 foldplates) and the sixteen page station (0, 2, 3, or 4 foldplates). The configuration screen further provides for the identification of the folder configuration, including the presence of a gatefold unit, knife unit, hang on stacker, and two tier stacker, for example. The background includes colored panels. The buttons include a next button that registers the configuration and a main button that terminates the configuration screen without registering any entries and proceeds to the main screen. Preferably, the configuration screen is password protected so as to prevent access by tutorial operators.

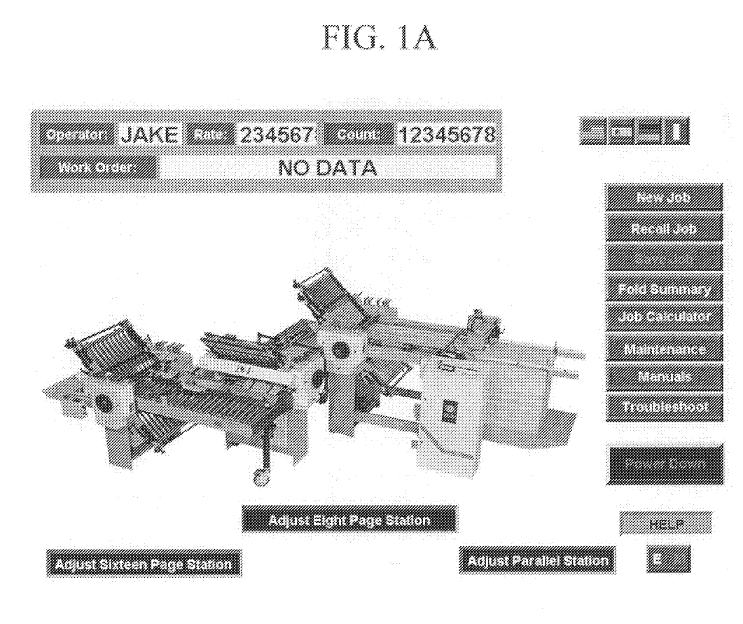

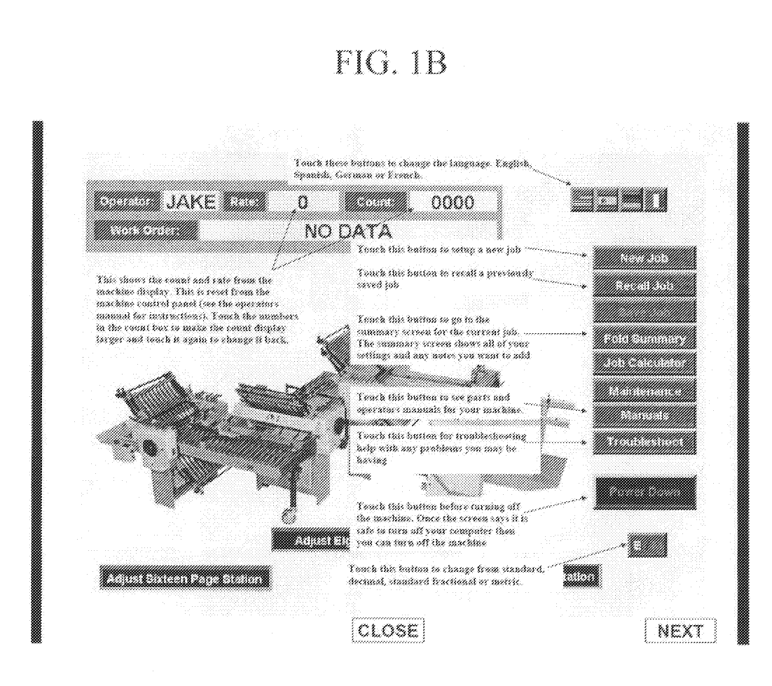

FIG. 1A shows the main screen which is the home screen for the tutorial. This screen provides the operator with information about the current job status and includes buttons enabling the operator to set up all folder functions. For example, the main screen is divided into four areas: the folder display area, the view selection area, the function selection area, and the job status display area. Additionally, a power down button is provided to enable the tutorial to be shut down, and a help button is provided to explain the current screen contents. The help button is located in the same location on each screen that may require explanation of the screen contents. In a preferred embodiment, the help button is located in the lower right corner of the screen. However, the help button may be located at any suitable location on the screen. FIG. 1B shows the help contents for the main screen with text boxes explaining the purpose and function of the different areas and buttons on the main screen.

The job status display area includes windows which indicate the operator's name or initials, the job or work order number, the fold rate (if accessible from a folder controller), and the sheet count. The operator's name or initials window also defines a log on/log off hot spot. Tapping this window displays a screen that enables changing of the operator. The job or work order number window also defines a job or work order entry screen. Tapping this window results in the initiation of a job or work order entry screen. The fold rate and sheet count windows display the current status of the folder with respect to the fold rate and sheet count. The main screen also displays the language selection button group and the measurement units toggle button first shown in the power up screen. Off line maintenance initiation hot spots are located at the upper left and upper right corners of the display area and permit the operator to terminate the tutorial by tapping opposite upper corners in quick succession and subsequent entry of a master password.

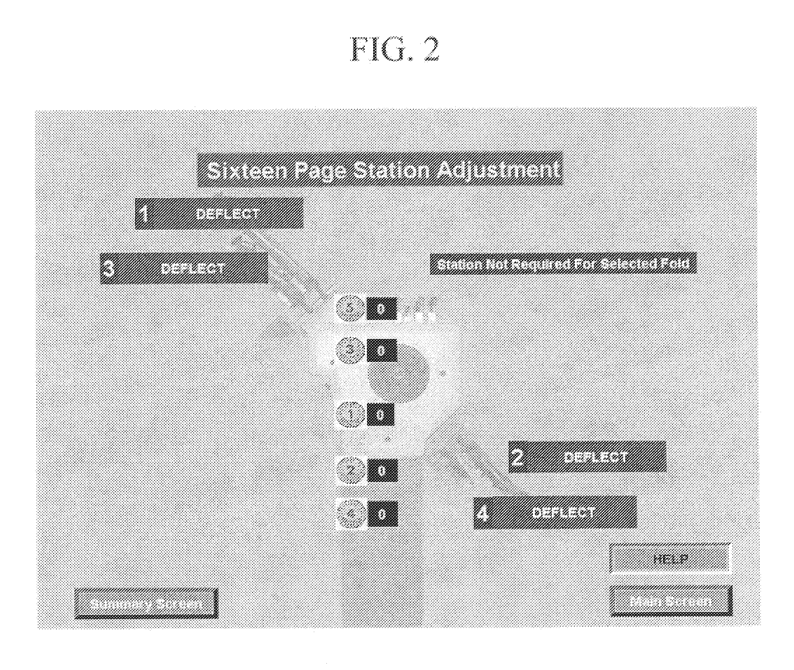

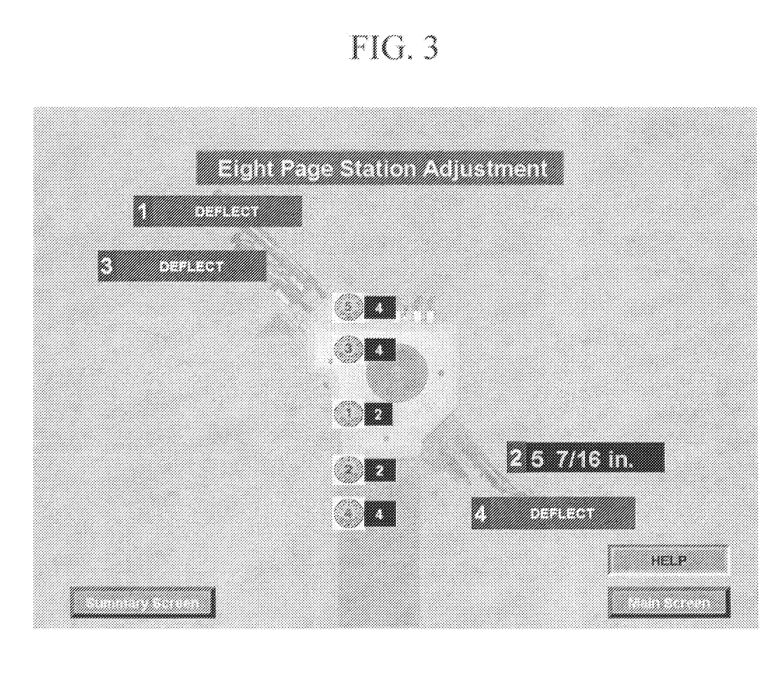

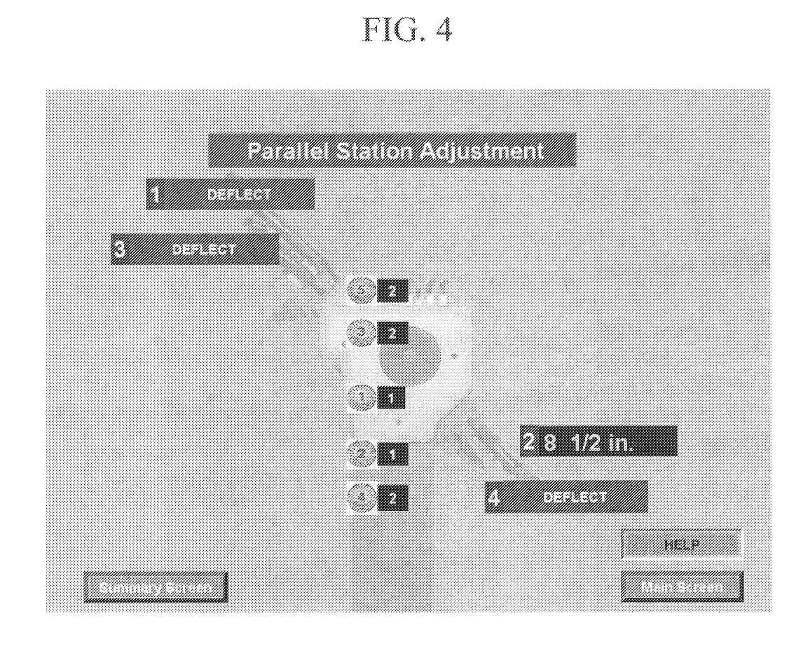

The view selection area includes three buttons. These include an adjust sixteen page station button, an adjust eight page station button, and an adjust parallel station button. FIG. 2 shows the sixteen page station adjustment screen when the adjust sixteen page station button is pressed. FIG. 3 shows the eight page station adjustment screen when its corresponding button is pressed on the main screen. FIG. 4 shows the parallel station adjustment screen when its corresponding button is pressed on the main screen.

The folder display area may include a picture of the folder. The default view displays either a folder including a stack feeder, a parallel unit, an eight page unit, and a delivery tray, or, if the configuration indicates that no eight page unit is present, a folder including a stack feeder, a parallel unit, and a delivery tray.

The function selection area includes a column of eight buttons. However, any suitable number of buttons and columns of buttons may be provided. These buttons initiate a screen (or start a sequence of screens) that provides the requested function. The setup function buttons include new job, recall job, save job, fold summary, job calculator, maintenance, manuals, and troubleshoot.

The new job button enables the operator to set up a new fold and the summary button displays a complete tabular description of the current job. The new job and summary buttons will be described in detail later.

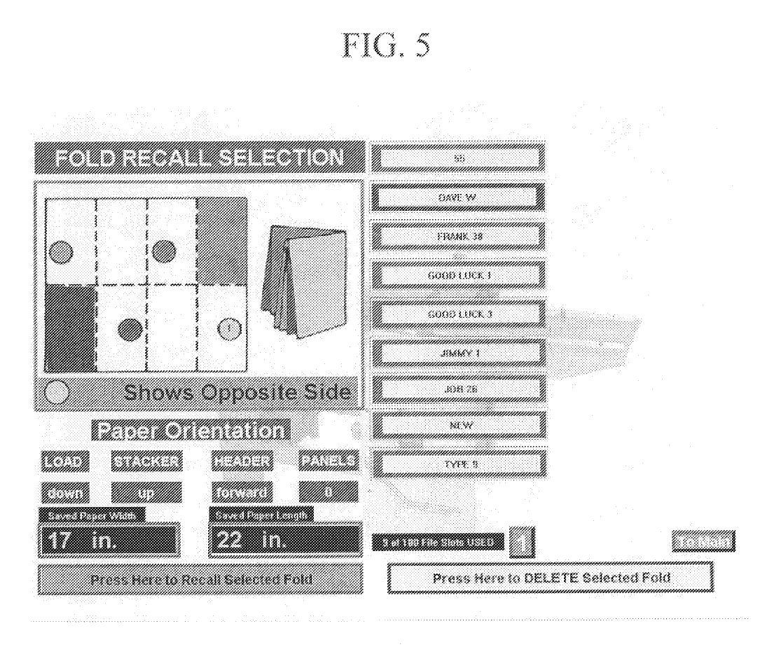

FIG. 5 shows the recall selection screen. Tapping the recall job button on the main screen displays the recall selection screen and enables the selection of a previously saved job. Recall is performed by entering the job name or by selecting a job from a listing of all jobs. The background information includes colored panels behind buttons and data entry/select fields. The graphic display includes a list of all prior jobs and a fold recall selection. The list may be displayed over several screens if the number of jobs precludes listing all jobs on a single screen. The fold recall selection displays a picture of the fold corresponding to a selected job and the paper size and orientation of the paper. The data display includes the currently saved jobs list and the data entry includes the job name to be recalled.

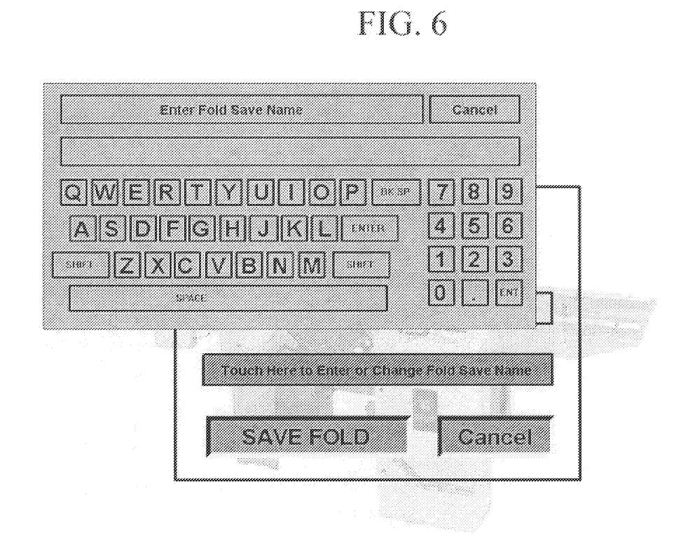

FIG. 6 shows the save job screen. Tapping the save job button on the main screen displays the save job screen and allows saving the currently active job by a job name. If the job was previously saved by that job name, an overwrite warning window appears. The background includes colored panels behind buttons and data entry/select fields. The graphic display includes the job name as entered or as previously saved. A cancel button is also provided which displays the main screen. The data display includes current job name or “???” if no job name has been entered. The data entry screen displays the job name.

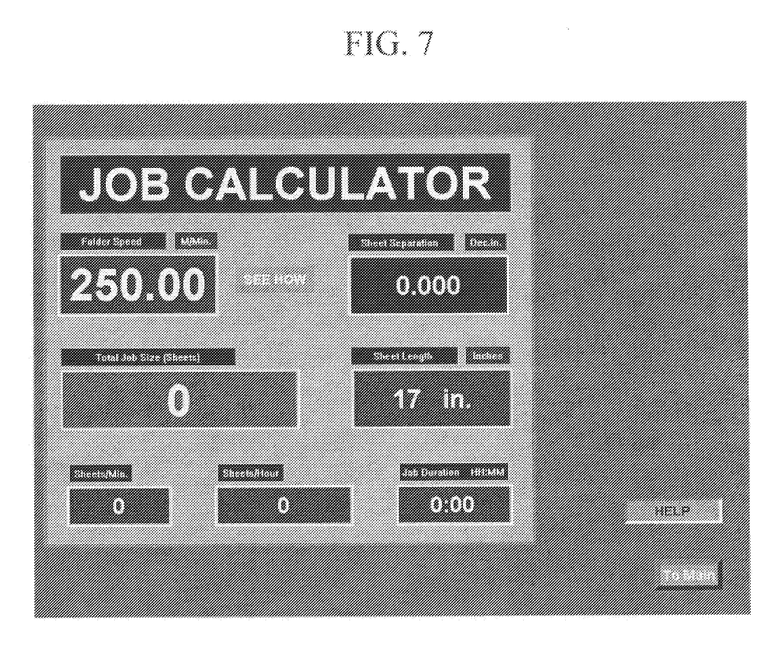

FIG. 7 shows the job calculator screen. Tapping the job calculator screen button on the main screen displays the job calculator. The job calculator calculates the production rate in sheets per minute based on the entry of gap, or sheet separation, size (in inches or millimeters according to the currently selected measurement units), entry or use of the already determined sheet length, and entry (or reading from the folder) of the folder speed setting. The folder speed setting is always in meters per minute. It will also estimate job hours and minutes if the total job size is entered. Thus, the true cost of a fold job can be accurately derived. The background includes colored panels behind buttons and data entry/select fields. The graphic display includes job rate/min (sheets/minute), folder speed (meters/minute), job rate/hr (sheets/hr), job duration (HH:MM), gap or sheet separation (as entered), sheet length (as entered), and total job size (as entered). A main button terminates the screen and returns the operator to the main screen. The data display includes the sheet length and the data entry includes the gap size (in. or mm) and total job size (count).

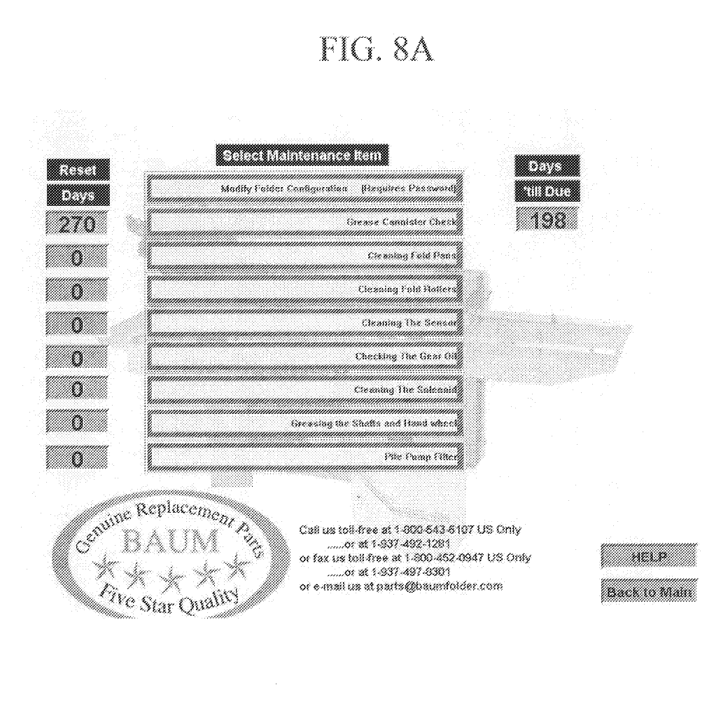

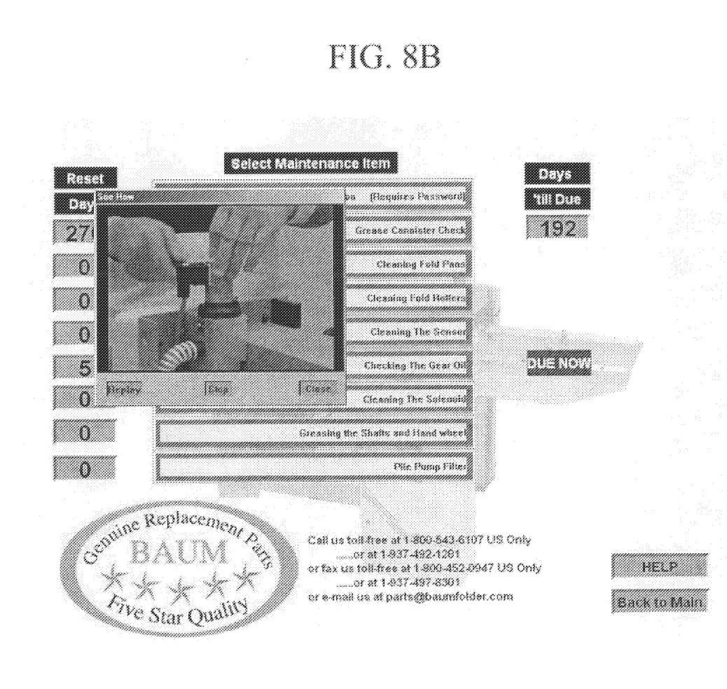

FIG. 8A shows the maintenance screen. Tapping the maintenance button on the main screen displays a column of options, each option including an associated button, a reset button, and a maintenance due indicator. The first option is to modify the folder configuration. Pressing this button initiates the configuration screen sequence. Further buttons are provided for other maintenance options with the corresponding name provided within the button. Pressing a button associated with a maintenance option displays a maintenance item screen, described below. A back to main button terminates the maintenance screen and returns the operator to the main screen. The background includes a folder, a logo, contact information regarding maintenance, or a plain color behind the text and buttons. The display includes text windows, each including one maintenance option and maintenance due indicators (green if not due, flashing red if due, and gray if not used). The buttons include a configure button which displays the configuration screen, maintenance option buttons which display a maintenance item screen, and a back to main screen button which displays the main screen. There is no data display or data entry for this screen.

FIG. 8B shows an example of a maintenance item screen. The maintenance item screen includes a jpeg image or video, or both, that provides information relevant to the selected maintenance item. The jpeg image includes text and/or pictures describing the periodic maintenance required for one item or part of the folder. In some screens, pressing the jpeg image further initiates an instructional video. Tapping the reset button on the maintenance screen indicates that the associated maintenance operation was completed, and resets the maintenance due counter. The maintenance due indicator flashes red when the associated counter has timed out. The counter contains the number of days remaining before the maintenance item is due to be performed again. A close button terminates the maintenance item screen and return the operator to the maintenance screen. The name of each of the maintenance options, and the initial setting and reset value of each of the timers are part of the tutorial system database. In order to indicate that a maintenance item is due to be performed, the maintenance button on the main screen and the associated maintenance due indicator on the maintenance screen begins to flash. The main screen indicator flashes until all of the maintenance items have been checked. The maintenance due indicators on the maintenance screen flash until the associated button is checked indicating maintenance item completion. The background information includes a frame containing the jpeg image and buttons dispersed below the frame. The graphic display includes the jpeg image. The buttons include the reset button that resets the counter indicating completion, a see how button that initiates an instructional video, a maintenance due indicator button that is normally green but flashes red if the counter times out, and a close button that terminates the screen. There are no display or data entry information for this screen.

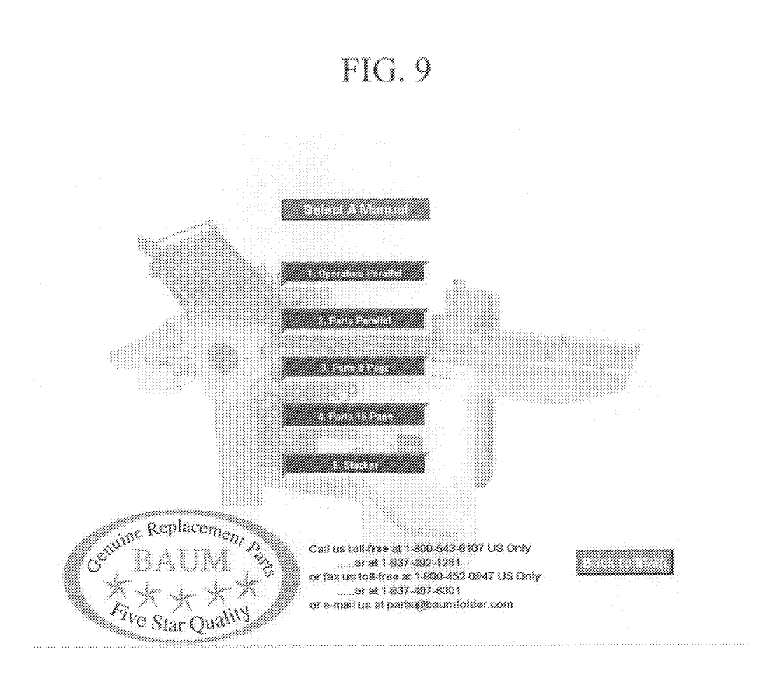

FIG. 9 shows the manuals screen with a list of operating manuals that can be accessed. Tapping the manuals button on the main screen enables the operator to select an operating manual for viewing. An individual button is provided for each manual. Pressing the button initiates a module, such as a PDF Viewer, which displays the selected manual and enable the operator to page through the manual. Within the module, the operator can select from previous, next, or close buttons. A main button returns the operator to the main screen after the manual viewing is complete. The background information includes a frame containing a jpeg image with buttons. The graphic display lists the operator manual names. The buttons include buttons that initiate a module, such as the PDF Viewer, and a main button that returns the operator to the main screen. There are no data display or data entry information for this screen.

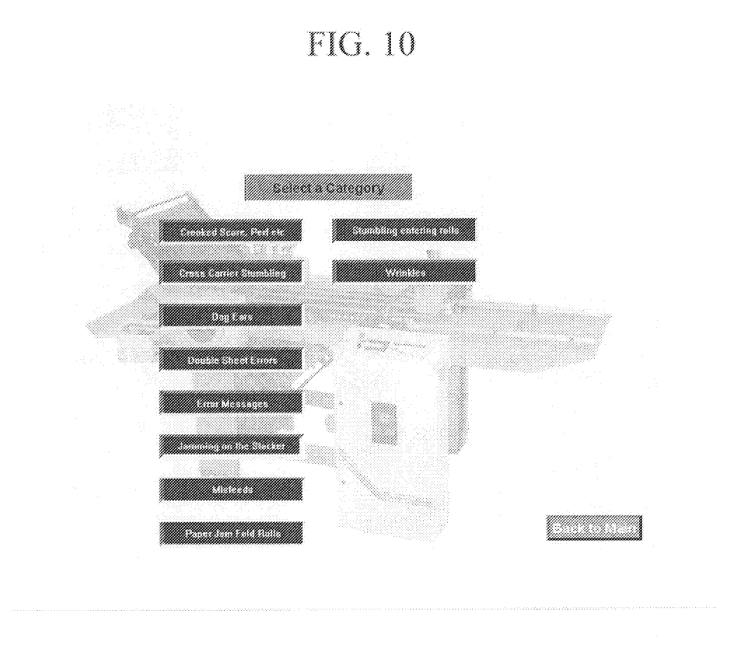

FIG. 10 shows the troubleshooting screen. Tapping the troubleshoot button on the main screen enables the operator to select from a list of troubleshooting categories which displays a text message relevant to the troubleshooting category. A troubleshooting category may be broken down into further categories listing possible sources of the trouble. Tapping on a further category displays an image with text or a video explaining how to fix the problem. A main button returns the operator to the main screen. The background information includes an image of a folder, a logo, or a plain colored panel. The graphic display includes the list of troubleshooting categories. The buttons include a button for each troubleshooting category and further troubleshooting category, if provided, and a main button that returns to the main screen. There are no text display or data entry information for this screen.

As mentioned above, tapping on the new job button enables the operator to set up a new fold. First and second setup screens provide for the initiation or entry of the fold selection, paper orientation, and paper size. These screens are the first screens in a multiscreen sequence used to set up a new fold job.

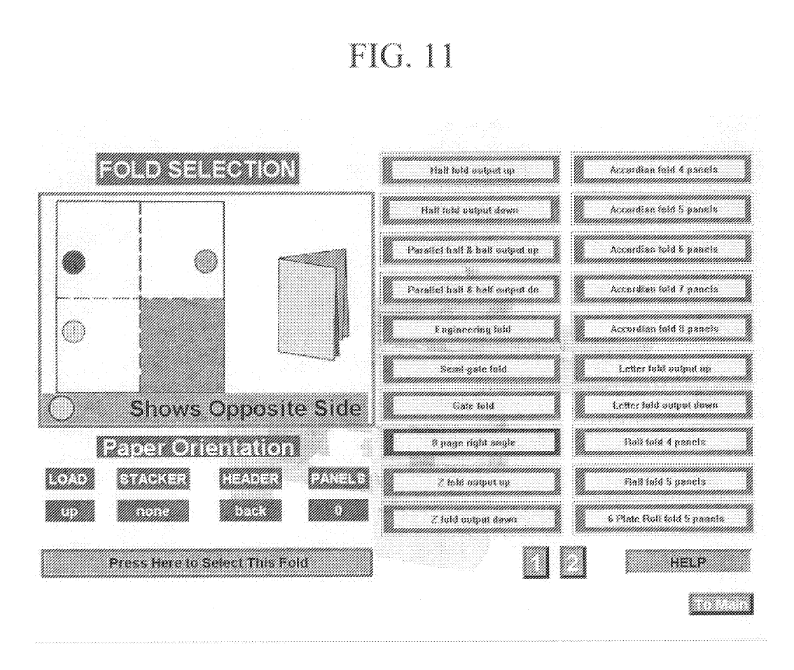

FIG. 11 shows the first setup, or fold selection, screen. The fold selection screen displays a matrix of fold buttons describing various folds and a larger selected fold open box. The matrix of fold buttons may be spread over several screens with buttons to enable scrolling between the several screens. Tapping a depicted fold within the matrix highlights the description of the fold and shows a picture of the fold in the selected fold box. An error is generated if the folder is not configured to perform the selected fold. Buttons are provided to select the highlighted fold or return to the main screen.

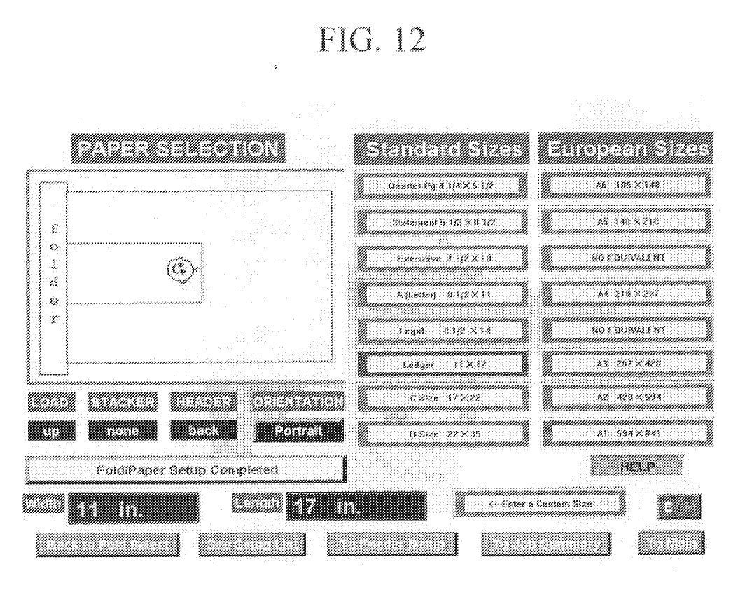

FIG. 12 shows the second setup screen. This screen displays a matrix of standard and European paper sizes, a paper orientation button, and two windows labeled paper width and paper length. Tapping a size moves the associated size into the paper width and paper length windows. Tapping the paper length or the paper width window displays a data entry keypad, enabling modification of either dimension. A select this paper size and orientation button selects the highlighted paper size and orientation. Further buttons allow the operator to display the fold select screen, setup list, feeder setup, job summary, or main screen. The data display includes the selected paper width and length and the data entry includes paper width and length. The data entry information includes paper width and length.

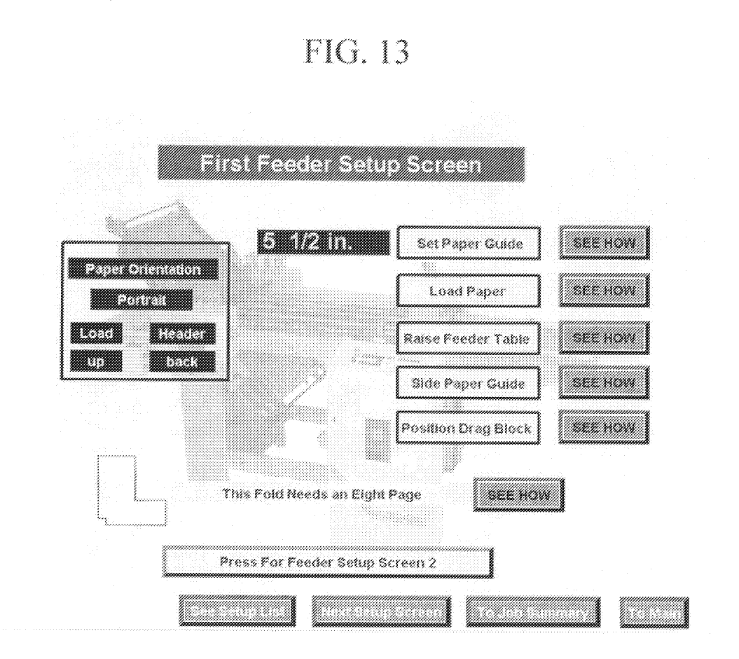

FIG. 13 shows a third setup screen, which is the first of two feeder set up screens. This screen instructs the operator as to the desired placement of the feeder paper guide, how to load and orient the paper relative to the folder intake, how to raise the feeder table into position for folding, how to set the side paper guide, and reminds the operator to move the sheet drag guide block. Each of these operations includes a see how button, which initiates a short instructional video. Additional instructions and see how buttons may also be provided depending upon the required stations for the fold job. Setup list, next, job summary, and main buttons are provided for proceeding to other screens in the folder setup. The background information includes colored panels behind buttons and data entry/select fields. The graphic display includes a paper orientation based on selected fold and stacker output options. The data display includes half of the paper width (or height if landscape orientation) as a guide to setting the feeder and a header or address position (up or down).

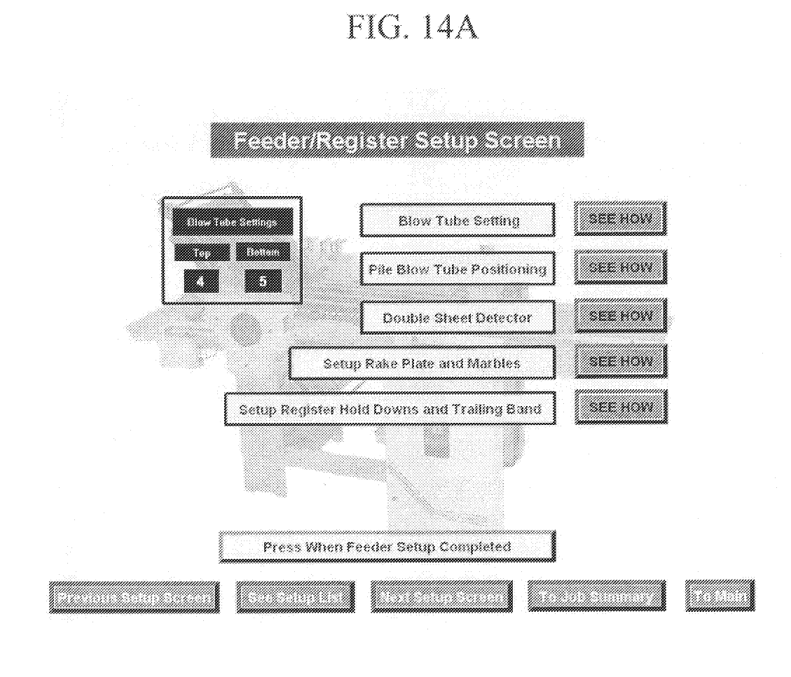

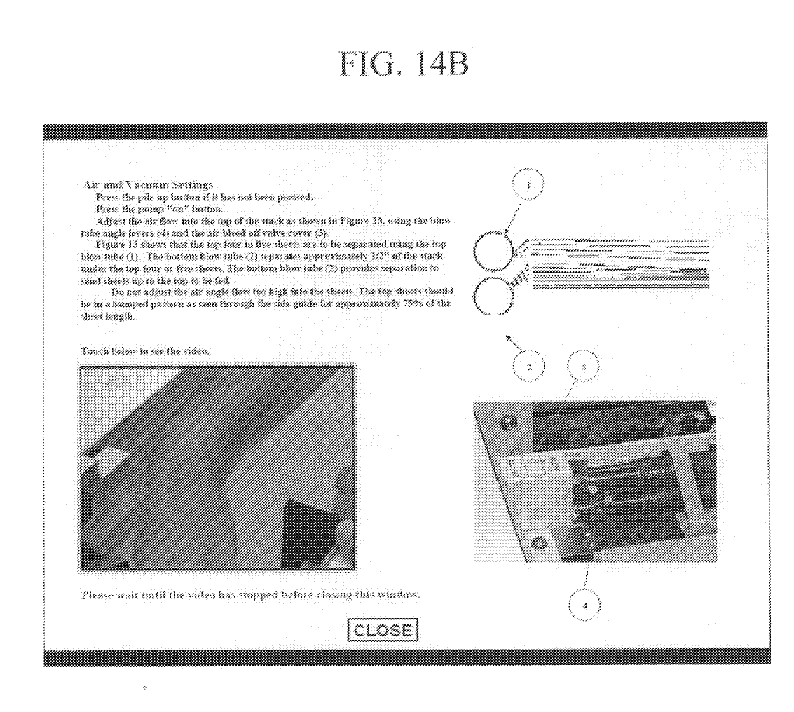

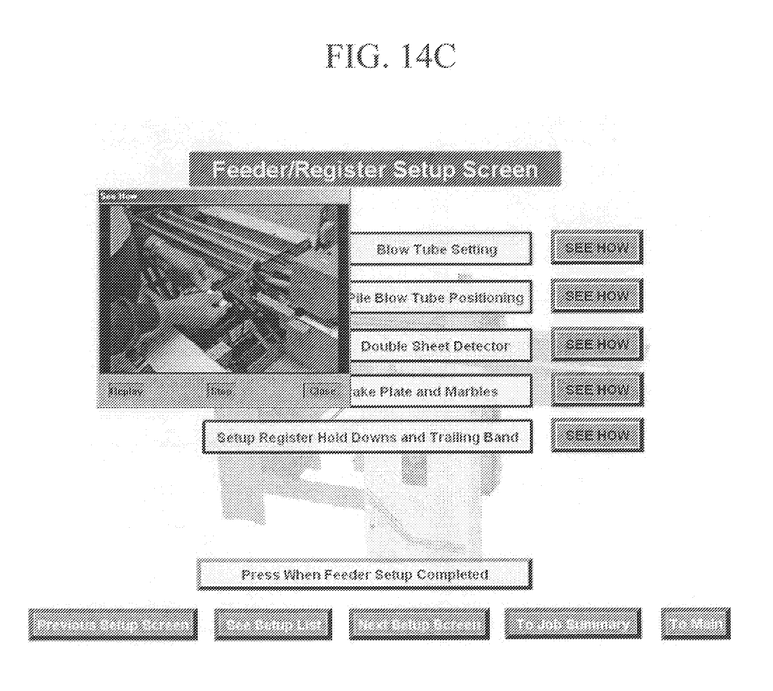

FIG. 14A shows a fourth setup screen, which is the second of the two feeder setup screens. This screen instructs the operator as to the top and bottom blow tubes, and provides see how buttons for positioning the blow tube settings, the pile blow tube positioning, the double sheet detector, the setup rake plate and marbles, and the setup register hold downs and trailing band. FIG. 14B shows an instructional video for positioning the blow tube settings after pressing the corresponding see how button and FIG. 14C shows an instructional video for the double sheet detector after pressing its corresponding see how button. Previous, setup list, next, job summary, and main buttons are provided for proceeding to other screens in the folder setup. The background information includes colored panels behind buttons and data entry/select fields. There is no graphic display information for this screen. The data display includes top and bottom blow tube positions.

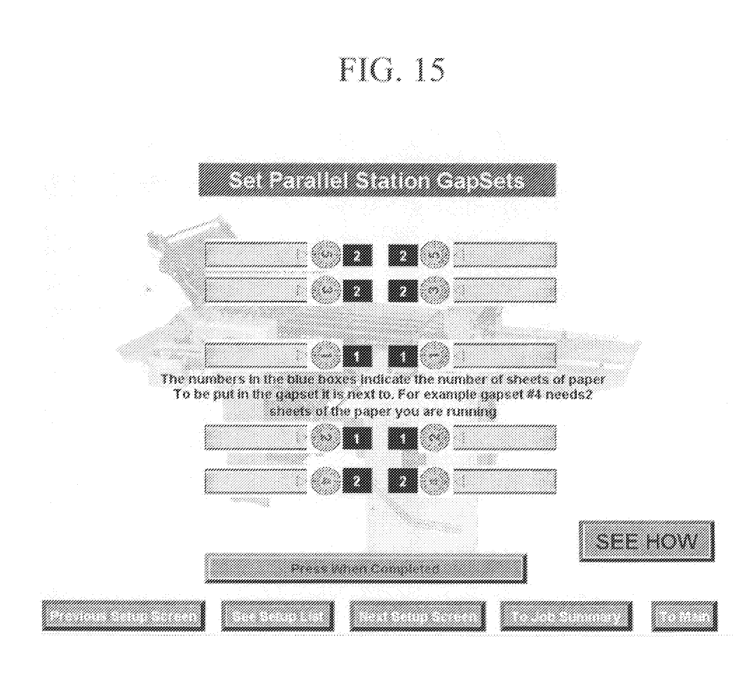

FIG. 15 shows a fifth setup screen that shows the operator how many sheets of the current paper stock are to be inserted into each of the parallel station gapsets. The operator may enter new sheet insert numbers if he wishes to override the standard or previously stored settings. A see how button starts an instructional video if further instruction is needed. Previous, setup list, next, job summary, and main screen buttons are provided for proceeding to other screens in the folder setup. The background information includes a picture of the gapsets to be set (based on the number of plates configured for the parallel station). There is no graphic display information for this screen. The data display includes gapset settings based on selected fold and parallel station configuration. The data entry information includes a gapset override for each gapset.

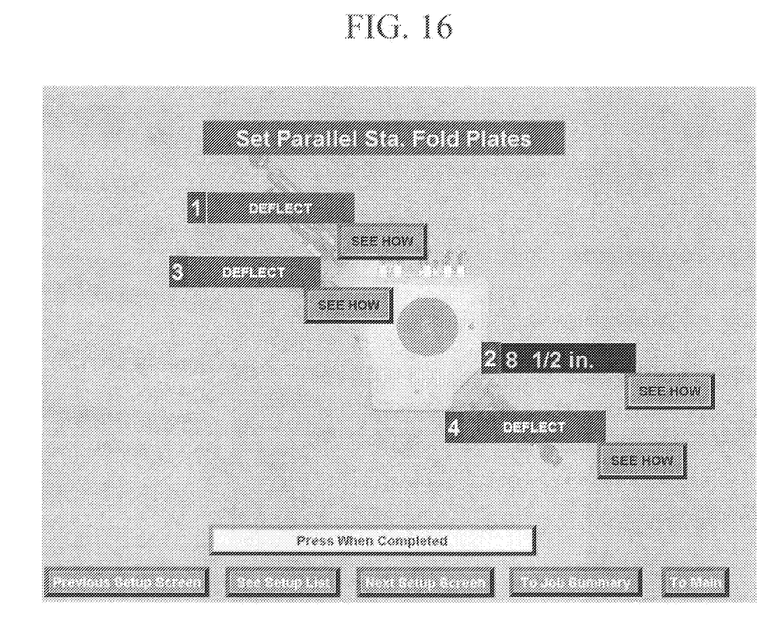

FIG. 16 is the sixth setup screen which shows the operator the required fold plate settings for the number of fold plates currently configured on the parallel station, based on the currently selected fold. The display of the plate settings is in inches and fractions of an inch (i.e., 3⅝, 4 7/16). The equivalent display on European machines is in millimeters. The operator may override the settings by tapping the window containing the current setting. This action initiates a data adjustment screen. A see how button is provided which initiates an instructional video. Previous, setup list, next, job summary, and main screen buttons are provided for proceeding to other screens in the folder setup. The background information includes colored panels behind buttons and data entry/select fields. The graphic display includes standard animation showing paper fold/rollers and fold plates. The data display includes the standard (or previously entered) position of each foldplate. The data entry information includes the override position of each foldplate.

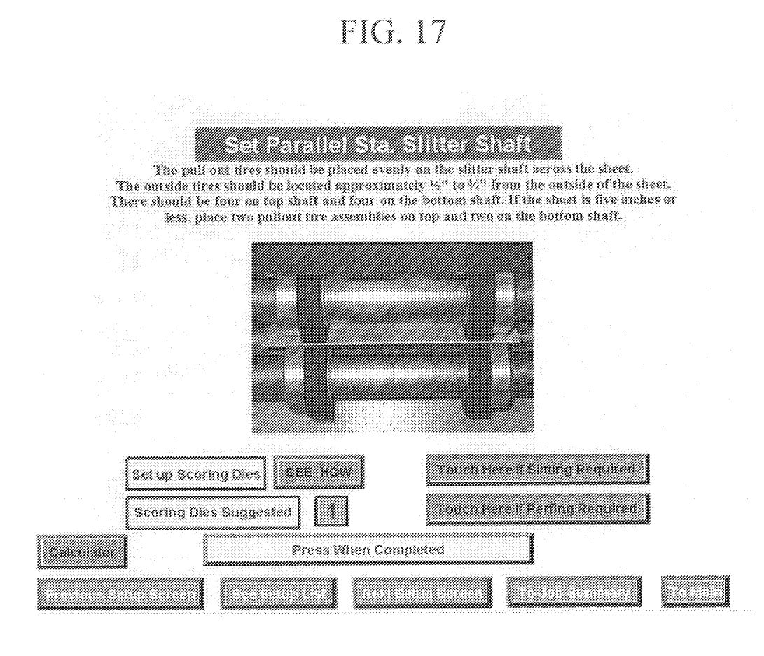

FIG. 17 is the seventh setup screen which shows the suggested number of scoring dies on the parallel station slitter shaft. The number of scoring dies is based on the selected fold. The remainder of the screen shows a general guide on slitting, perfing, and scoring. The information on this screen is not alterable by the operator. A see how button initiates an instructional video. Previous, setup list, next, job summary, and main screen buttons are provided for proceeding to other screens in the folder setup. The background information includes colored panels behind buttons and data entry/select fields. The graphic display includes the suggested number of scoring dies. Further buttons include touch here buttons if slitting or perfing is required and a calculator button. The data display includes the number of suggested scoring dies. There is no data entry information for this screen.

An eighth setup screen, not shown, informs the operator that the setup of the feeder and parallel stations is complete, and instructs the operator to run a test sheet to verify correct setup of these stations. A see how button initiates an instructional video. Previous, setup list, next, job summary, and main screen buttons are provided for proceeding to other screens in the folder setup. The background information includes colored panels behind buttons. There is no graphic display information for this screen. There is no data display information for this screen.

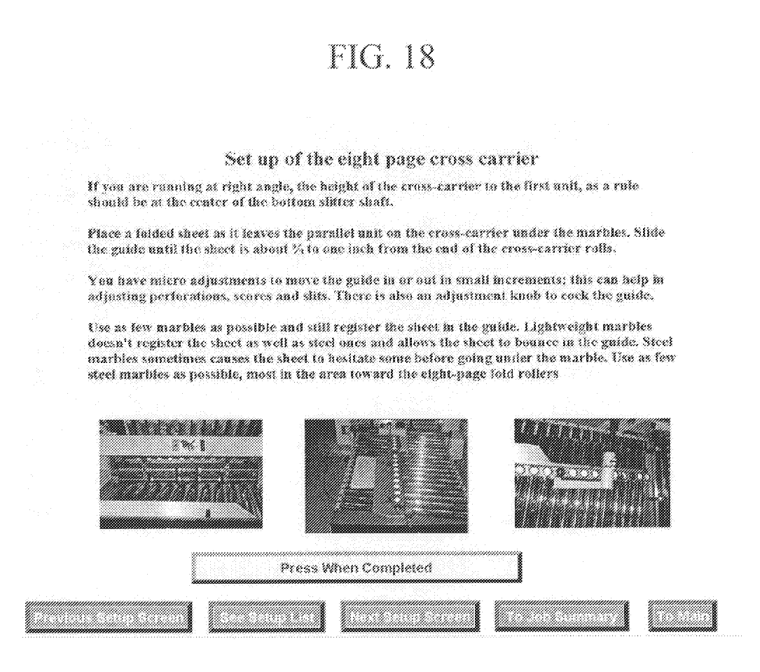

FIG. 18 shows a ninth setup screen for setting up an eight page station cross-carrier. This screen instructs the operator to put a piece of paper on the cross carrier, one inch from the edge of the rolls, and move the marble holder up to the paper. Note that this screen is not displayed if an eight page station is not required by the fold or is not indicated by the folder configuration. A variable second line indicates that the eight page setup is normal or that the eight page setup is tandem, depending on the fold selected. See how buttons may be provided to initiate cross carrier setup, cross carrier normal, and cross carrier tandem instructional videos. Previous, setup list, next, job summary, and main screen buttons are provided for proceeding to other screens in the folder setup. The background information includes a diagram of the cross-carrier with the paper placed in correct position. There is no graphic display for this screen. There is no data display information for this screen.

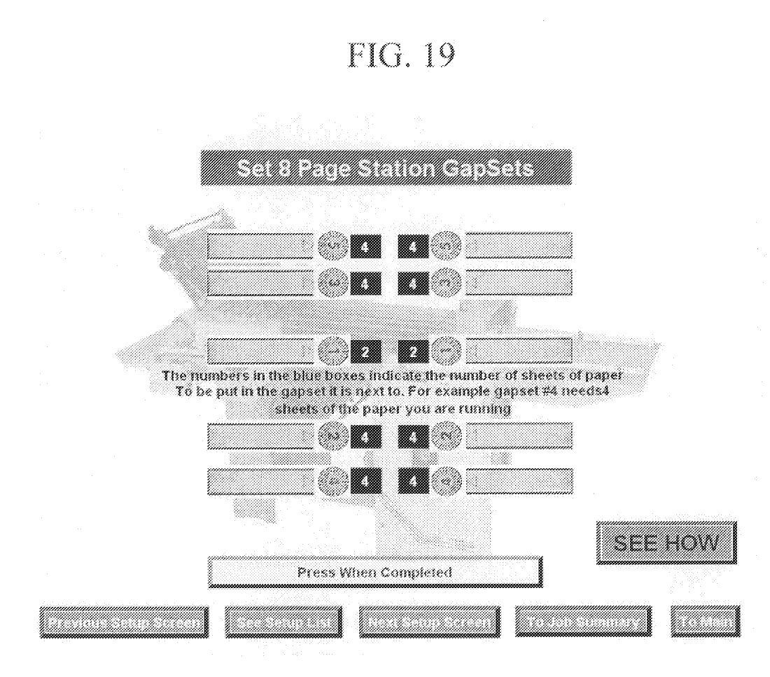

FIG. 19 is a tenth setup screen which shows the operator how many sheets of the current paper stock are to be inserted into each of the eight page station gapsets. Note that this screen is not displayed if the fold does not require an eight page station or is not indicated by the folder configuration. The operator may enter new sheet insert numbers if he wants to override the standard or previously stored settings. A see how button that starts an instructional video is provided. Previous, setup list, next, job summary, and main screen buttons are provided for proceeding to other screens in the folder setup. The background information includes a picture of the gapsets to be set based on the number of plates configured for the eight page station. There is no graphic display information for this screen. The data display includes gapset settings based on the selected fold and eight page station configuration. The data entry includes gapset override for each gapset.

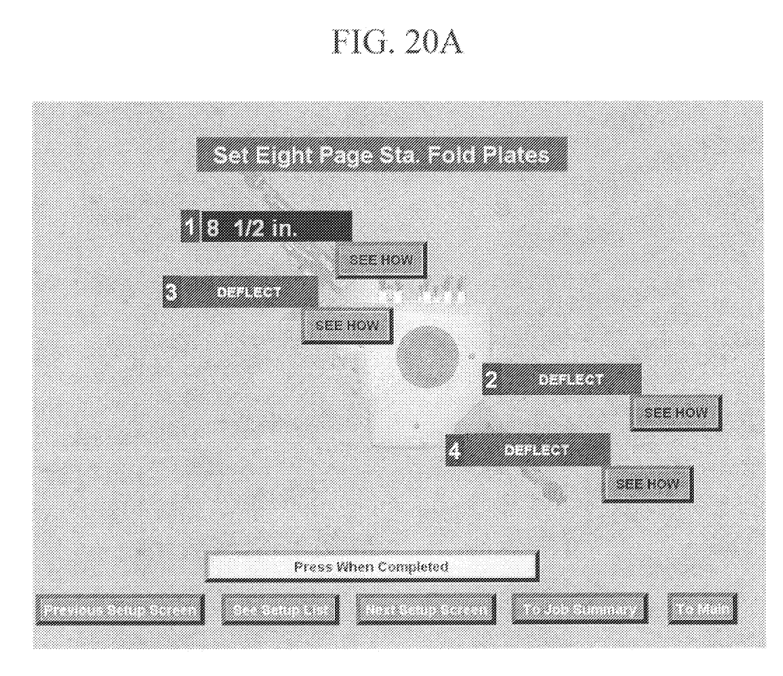

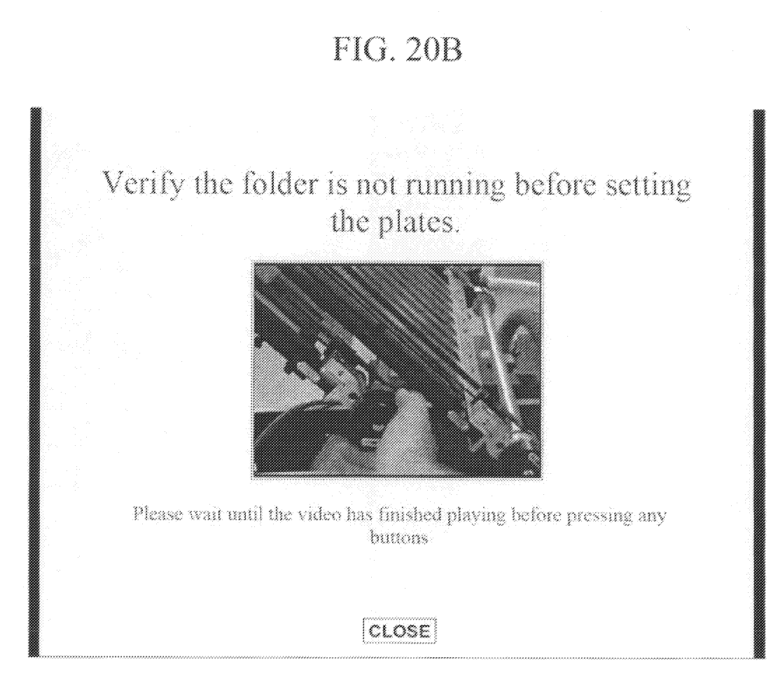

FIG. 20A shows an eleventh setup screen. This screen shows the operator the required fold plate settings for the number of fold plates currently configured on the eight page station, based on the currently selected fold. Note that this screen is not displayed if the fold does not require an eight page station or is not indicated by the folder configuration. The display of the plate settings is in inches and fractions of an inch (i.e. 3⅝, 4 7/16). The equivalent display on European machines is in millimeters. The operator may override the settings by tapping the window containing the current setting. This action initiates a data adjustment screen. A see how button is provided which initiates an instructional video, as shown in FIG. 20B. Previous, setup list, next, job summary, and main screen buttons are provided for proceeding to other screens in the folder setup. The background information includes colored panels behind buttons and data entry/select fields. The graphic display includes standard animation showing paper fold/rollers and fold plates. The data display includes the standard position of each foldplate. The data entry information includes the override location for each foldplate.

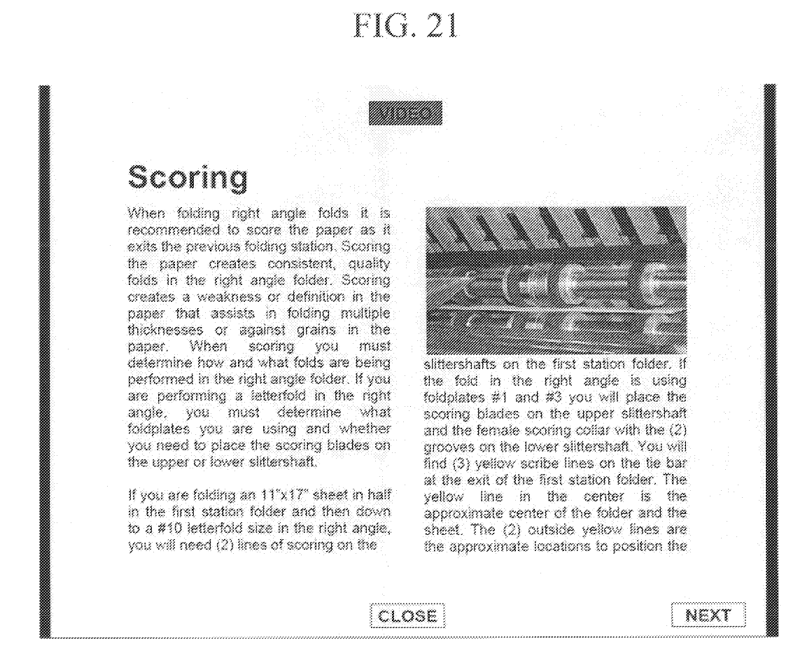

A twelfth setup screen, not shown, includes a window showing the suggested number of scoring dies on the eight page station slitter shaft. The number of scoring dies is based on the selected fold. The remainder of the screen shows a general guide on slitting and scoring. The information on this screen is not alterable by the operator. A see how button initiates an instructional video, as shown in FIG. 21. Previous, setup list, next, job summary, and main screen buttons are provided for proceeding to other screens in the folder setup. The background information includes colored panels behind buttons and data entry/select fields. The graphic display includes the suggested number of scoring dies. Further buttons include touch here buttons if slitting or perfing is required and a calculator button. The data display includes a number of suggested scoring dies. There is no data entry information for this screen.

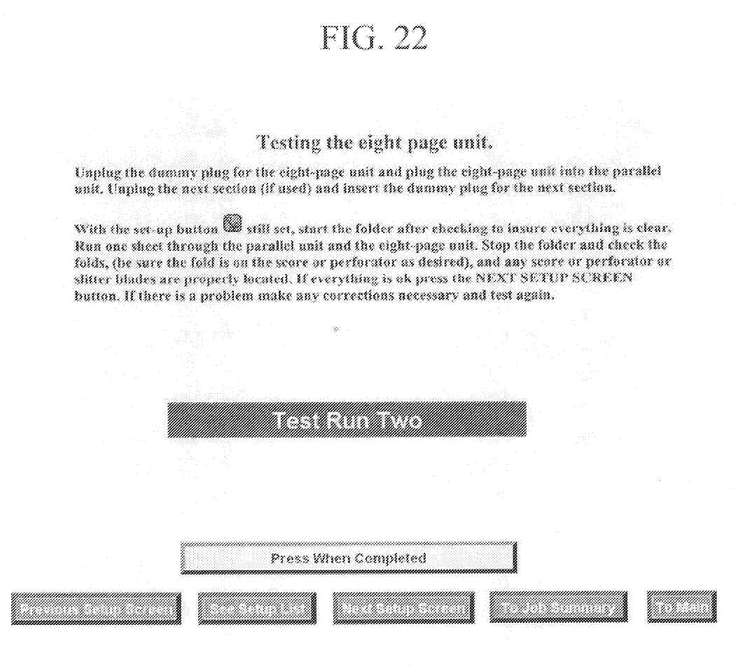

FIG. 22 is a thirteenth setup screen and informs the operator that the setup of the eight page station is complete, and instructs the operator to run a second test sheet to verify correct setup of the eight page station. Previous, setup list, next, job summary, and main screen buttons are provided for proceeding to other screens in the folder setup. The background information includes colored panels behind buttons. There is no graphic display information for this screen.

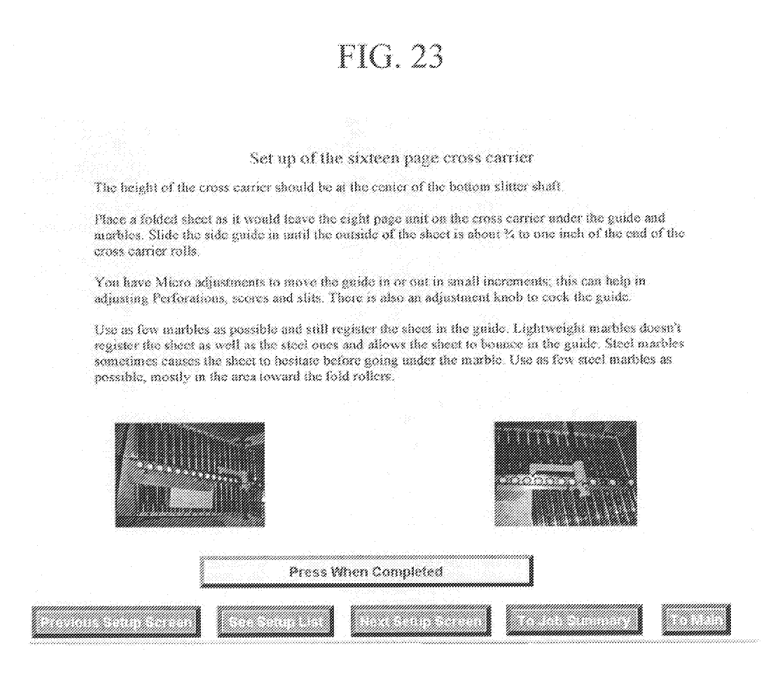

FIG. 23 is a fourteenth setup screen that permits the operator to set up a third (sixteen page) station cross-carrier. This screen instructs the operator to put a piece of paper on the cross carrier, one inch from the edge of the rolls, and move the marble holder up to the paper. Note that this screen is not shown if the fold does not require a sixteen page station or is not indicated by the folder configuration. A see how button initiates an instructional video. Previous, setup list, next, job summary, and main screen buttons are provided for proceeding to other screens in the folder setup. The background information includes a diagram of a cross-carrier with paper located in the correct position. The graphic display has no information for this screen. There is no data display for this screen.

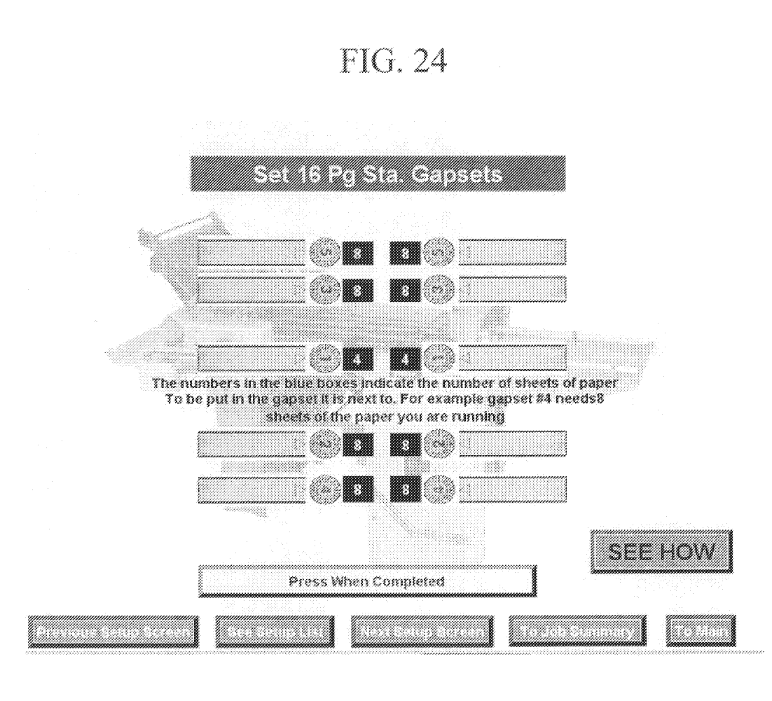

FIG. 24 is a fifteenth setup screen that permits the operator to set up the third (sixteen page) station gapsets. This screen instructs the operator how many sheets of the current paper stock are to be inserted into each of the sixteen page station gapsets. Note that this screen is not shown if the fold does not require a sixteen page station or is not indicated by the folder configuration. The operator may enter new sheet insert numbers if he wants to override the standard or previously stored settings. A see how button that starts an instructional video is provided. Previous, setup list, next, job summary, and main screen buttons are provided for proceeding to other screens in the folder setup. The background information includes a picture of the gapsets to be set based on the number of plates configured for the sixteen page station. There is no graphic display information for this screen. The data display includes gapset settings based on the selected fold and the sixteen page station configuration. The data entry includes gapset override for each gapset.

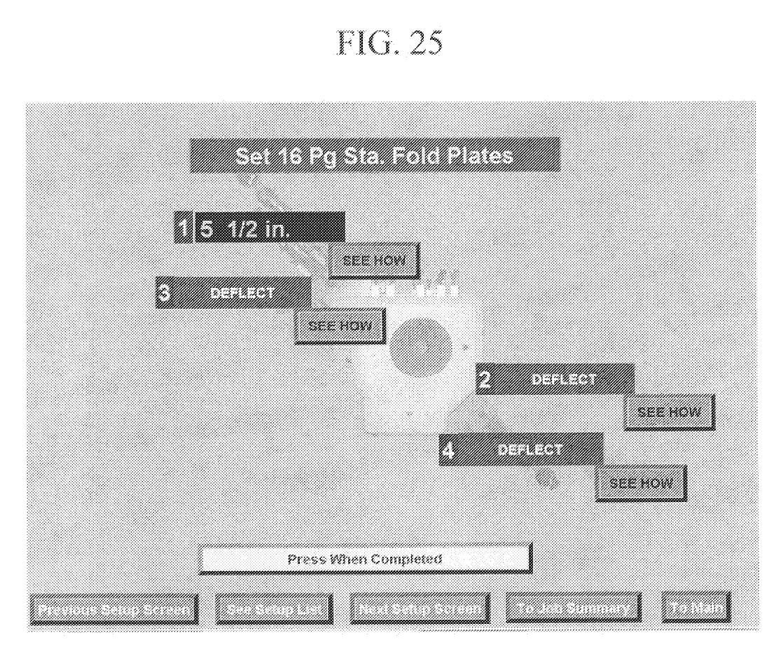

FIG. 25 is a sixteenth setup screen the permits the operator to set up the sixteen page station foldplates. This screen shows the operator the required fold plate settings for the number of fold plates currently configured on the sixteen page station, based on the currently selected fold. Note that this screen is not shown if the fold does not require a sixteen page station or is not indicated by the folder configuration. The display of the plate settings is in inches and fractions of an inch (i.e. 3⅝, 4 7/16). The equivalent display on European machines is in millimeters. The operator may override the settings by tapping the window containing the current setting. This action initiates a data adjustment screen. A see how button is provided which initiates an instructional video. Previous, setup list, next, job summary, and main screen buttons are provided for proceeding to other screens in the folder setup. The background information includes colored panels behind buttons and data entry/select fields. The graphic display shows standard animation showing paper fold/rollers and fold plates. The data display includes the standard position of each foldplate and the date entry includes override location for each foldplate.

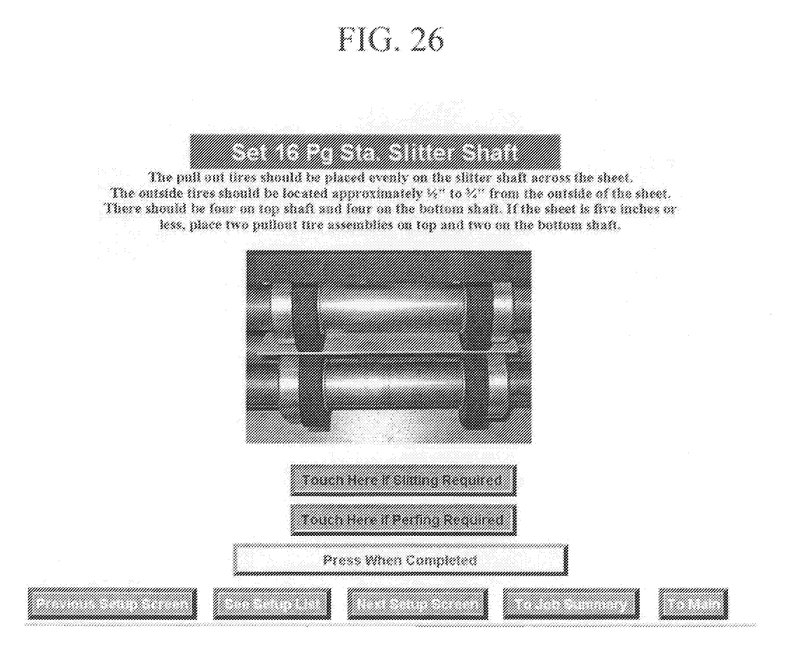

FIG. 26 is a seventeenth setup screen that permits an operator to set up the sixteen page station slitter shaft (pullouts). This screen shows the suggested position of pullout tires on the sixteen page station slitter shaft. The diagram shows pullout tires evenly spaced across the slitter shaft. This screen includes no data, and its contents are not alterable by the operator. A see how button initiates an instructional video. Previous, setup list, next, job summary, and main screen buttons are provided for proceeding to other screens in the folder setup. The background information includes colored panels behind buttons and data entry/select fields. The graphic display includes pullout tires on slitting shaft. Further buttons include touch here buttons if slitting or perfing is required. There is no data display for this screen.

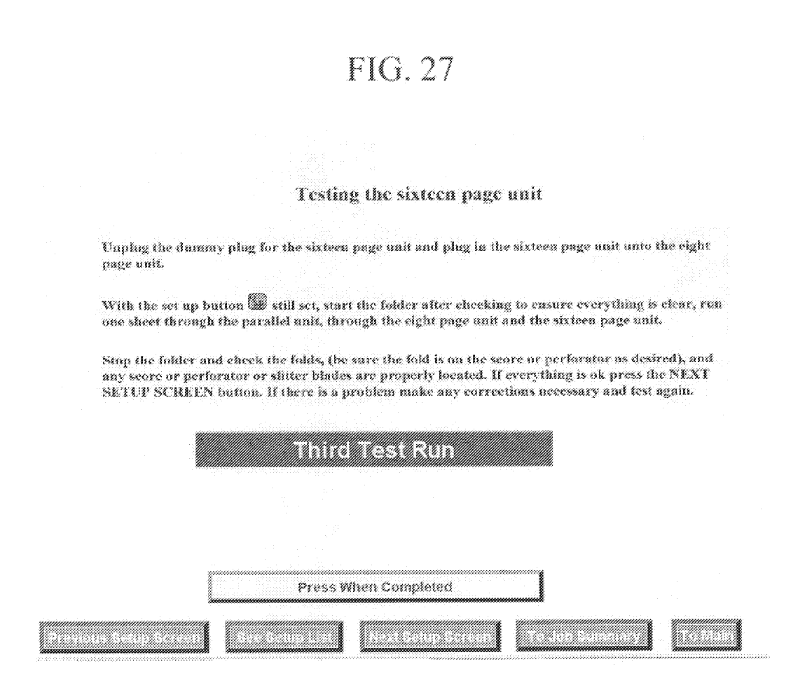

FIG. 27 is an eighteenth setup screen that shows a third test run. This screen informs the operator that the setup of the job is complete, and instructs the operator to run a test sheet to verify correct setup of all the stations. A see how button may be provided to initiate an instructional video. Previous, setup list, next, job summary, and main screen buttons are provided for proceeding to other screens in the folder setup. The background information includes colored panels behind buttons. There is no graphic display information for this screen. There is no data display information for this screen.

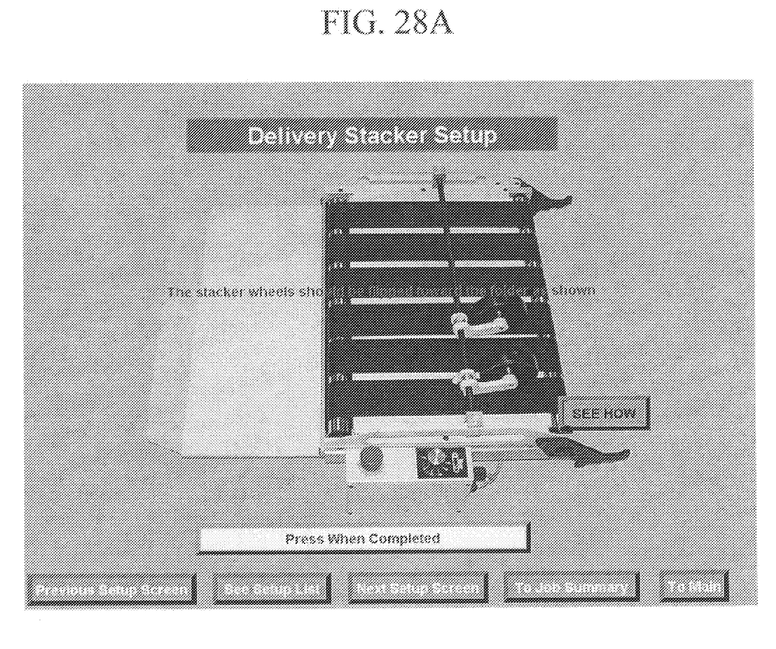

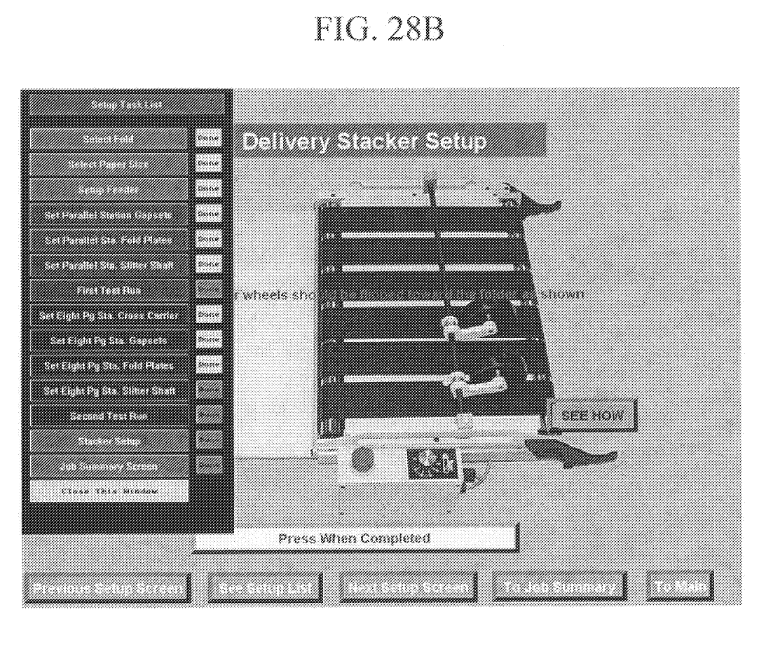

FIG. 28A is a nineteenth setup screen that shows a generic (jpeg) text and picture guide for setting up a delivery stacker. A see how button initiates an instructional video. Previous, setup list, next, job summary, and main screen buttons are provided for proceeding to other screens in the folder setup. The background information includes colored panels behind buttons and data entry/select fields. The graphic display includes a generic delivery stacker setup text and picture. There is no data display information for this screen. FIG. 28B shows the nineteenth setup screen with a displayed setup list. The setup list confirms whether or not the previous setups have been completed.

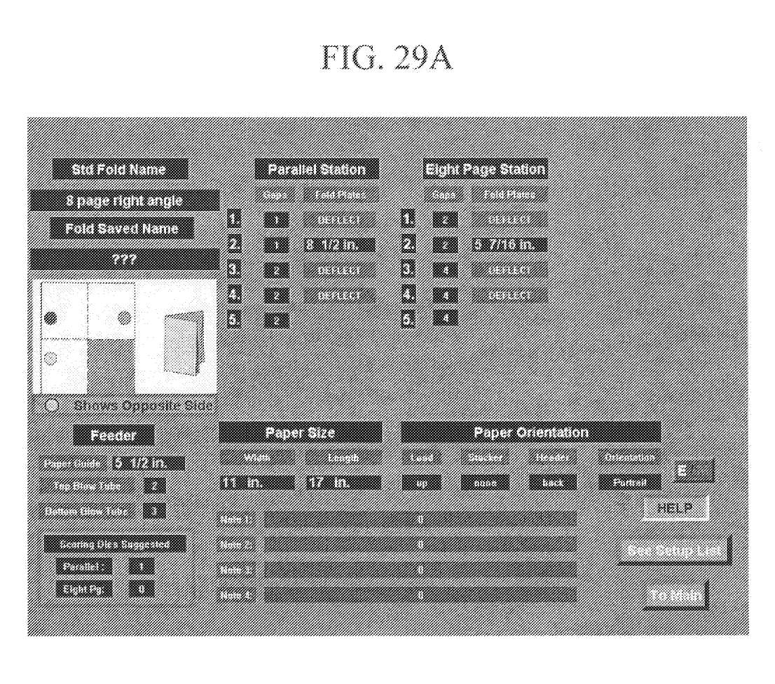

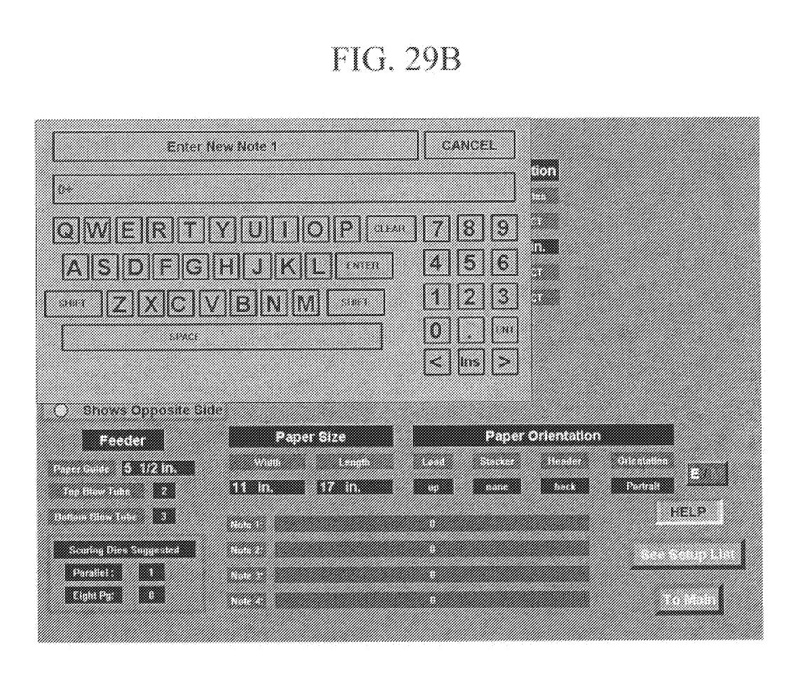

FIG. 29A shows the fold summary screen after the fold summary button on the main screen is pressed. This screen provides a complete tabular (spreadsheet-like) description of the current job, including all foldplate, gapset and other settings, production information (size and speed setting) and operator notes. Tapping any cell within the tabular description initiates a screen enabling a change to the value. There is no background information for this screen. The graphic display includes foldplate and gapset settings for all stations. The buttons include a main button that displays the main screen. The data display includes a complete job status box.

FIG. 29B shows a job notes screen which enables an operator to enter and save comments regarding each job. Each comment, called a note, includes a note number, operator initials, time and date that the note was entered, and up to 4 lines of 64 characters each. This screen also enables the operator to view previously entered notes. The exact format of this screen is flexible, and any suitable format may be used. A number of notes are shown and tapping on the note permits editing of the note. Alternatively, tapping on a blank note displays a data entry keyboard to enable the entry of a new note. Enter and cancel keys are provided to complete the transaction. The background includes colored panels behind buttons and data entry/select fields. The graphic display includes one or more previously entered notes. The data display includes a current note list and a data entry for a new or edited note.

One major advantage of the tutorial system is that it allows thorough, yet cost effective, training for unskilled operators while eliminating downtime of the folder for training purposes. However, the tutorial system may be upgraded and integrated with an actual folder to automatically set up and control the folder. Thus, a new operator is already intimately familiar with both the folder and the automation system since the tutorial and the upgraded automation system utilize the same screens. Furthermore, all of the teaching information in the tutorial including the manuals, the see how videos, and the maintenance and troubleshooting screens are immediately available to the new operator if a question or problem should arise during an actual operation of the folder. The full integration of the tutorial into the automation system provides benefits not contemplated by the prior art.

The present invention is not limited as to the type of computer operating system on which it runs. The tutorial may be stored on any type of computer memory or computer-readable medium including, but not limited to, floppy disks, conventional hard disks, CD-ROMS, Flash ROMS, nonvolatile ROM, and RAM. Data entry into the tutorial and selection of displayed information may be made using a keypad, keyboard, mouse, touch screen, or any other suitable input device. The tutorial may be used with any type of visual display.

The present invention is not limited to each of the above-described preferred embodiments, and various modifications are possible within the range described in the claims. Embodiments obtained by appropriately combining technical features disclosed in each of the different preferred embodiments are included in the technical scope of the present invention.

What is claimed is:

1. A computerized tutorial method for training an operator to operate a folding machine, comprising:
displaying on a display functions of the folding machine and information regarding the folding machine;
selecting one of the functions and information from the displayed functions and information based on input from the operator;
inputting, selecting, or retrieving data based on the selected one of the plurality of functions and information; and
operating the computerized tutorial in a state in which the computerized tutorial is disconnected from the folding machine so as not to control any functions of the folding machine.

2. The computerized tutorial method of claim 1, wherein the displayed information is not used to control the functions of the folding machine.

3. The computerized tutorial method of claim 2, wherein the displayed information is at least one of an operating manual, a maintenance procedure, and a troubleshooting operation.

4. The computerized tutorial method of claim 1, further comprising the step of, after the training of the operator has been completed, using the computerized tutorial method to control the folding machine using the functions provided in the computerized tutorial method.

5. The computerized tutorial method of claim 1, wherein the step of inputting, selecting or retrieving data is performed using a touch screen of the display.

6. The computerized method of claim 1, wherein the information includes videos which display various operations regarding the folding machine.

7. A system for training an operator to operate a folding machine, comprising:
a storage device in which functions of the folding machine and information regarding a folding machine are stored;
a display on which the functions of the folding machine and information regarding the folding machine are displayed; and
an input device provided to allow the operator to select one of the functions and information displayed on the display; wherein
the system can be disconnected from the folding machine during the training of the operator during which the system does not control any functions of the folding machine and operates only as a tutorial.

8. The system of claim 7, wherein the displayed information is not used to control the functions of the folding machine.

9. The system of claim 8, wherein the displayed information is at least one of an operating manual, a maintenance procedure, and a troubleshooting operation.

10. The system of claim 7, wherein the system can be connected to the folding machine after the training of the operator has been completed and can control the functions of the folding machine using the displayed functions.

11. The system of claim 7, wherein the input device is a touch screen of the display.

12. The system of claim 7, wherein the information includes videos which display various operations regarding the folding machine.

13. A computer-readable medium having computer-executable instructions for performing a method, comprising:
displaying on a display functions of a folding machine and information regarding the folding machine;
selecting one of the functions and information from the displayed functions and information based on user input;
inputting, selecting, or retrieving data based on the selected one of the functions and information; and
tutoring the operator to operate a folding machine independent of the folding machine so as not to control any functions of the folding machine.

14. The computer-readable medium of claim 13, wherein the displayed information is not used to control the functions of the folding machine.

15. The computer-readable medium of claim 14, wherein the displayed information is at least one of an operating manual, a maintenance procedure, and a troubleshooting operation.

16. The computer-readable medium of claim 13, further comprising the step of, after the training of the operator has been completed, controlling the functions of the folding machine using the displayed functions.

17. The computer-readable medium of claim 13, wherein the information includes videos which display various operations regarding the folding machine.

18. A system for training an operator to operate a folding machine, comprising:
means for storing functions of the folding machine and information regarding the folding machine;
means for displaying functions of the folding machine and information regarding the folding machine; and
means for selecting a desired function of the folding machine or information regarding the folding machine in response to an input from the operator; wherein
the system can be disconnected from the folding machine during the training of the operator during which the system does not control any functions of the folding machine and operates only as a tutorial.

19. The system of claim 18, wherein the displayed information is not used to control the functions of the folding machine.

20. The system of claim 19, wherein the displayed information is at least one of an operating manual, a maintenance procedure, and a troubleshooting operation.

21. The system of claim 18, wherein the system can be connected to the folding machine after the training of the operator has been completed and can control the functions of the folding machine using the displayed functions.

22. The system of claim 18, wherein the means for selecting is a touch screen of the display.

23. The system of claim 18, wherein the information includes videos which display various operations regarding the folding machine.

24. In a computer system having a graphical user interface including a display and a selection device, a method of providing and selecting from a menu on the display, comprising:
displaying a menu of functions of a folding machine and information regarding the folding machine to an operator;
receiving a menu selection signal indicating which of the functions and information was selected with the selection device;
displaying data in response to the selected function or information; and
operating the computer system in a state in which the computer system is disconnected from the folding machine so that the computer system does not control the functions of the folding machine.
